(19) United States
(12) Patent Application Publication
(10) Pub. No.: US 2022/0148791 A1
(43) Pub. Date: May 12, 2022

(54) COIL COMPONENT AND METHOD FOR MANUFACTURING COIL COMPONENT

(71) Applicant: Murata Manufacturing Co., Ltd., Kyoto-fu (JP)

(72) Inventors: Shigeto YAMAMOTO, Nagaokakyo-shi (JP); Shingo Nakamoto, Nagaokakyo-shi (JP); Kaori Takezawa, Nagaokakyo-shi (JP); Takuya Ishida, Nagaokakyo-shi (JP)

(73) Assignee: Murata Manufacturing Co., Ltd., Kyoto-fu (JP)

(21) Appl. No.: 17/454,215

(22) Filed: Nov. 9, 2021

(30) Foreign Application Priority Data
Nov. 12, 2020 (JP) 2020-188469

(51) Int. Cl. H01F 27/28; H01F 27/26; H01F 27/29; H01F 41/069

(52) U.S. Cl. CPC H01F 27/2828; H01F 27/266; H01F 41/0246; H01F 41/069; H01F 27/292

(57) ABSTRACT

A coil component includes a columnar winding core and flanges at ends of the winding core in positive and negative X directions and which protrude outward in a Z direction orthogonal to the X direction. A first wire is wound around the winding core. A metal terminal attached to the flange includes a reception portion extending away from the winding core in a length direction. A direction in which a dimension of the reception portion is the smallest in directions orthogonal to the length direction is a thickness direction, and a width direction is orthogonal to the length and thickness directions. The reception portion and the first wire are connected by a melted portion whose maximum dimension in the width direction is larger than a maximum dimension of the reception portion in the width direction and is at a portion away from the reception portion in the thickness direction.

### CROSS-REFERENCE TO RELATED APPLICATION

This application claims benefit of priority to Japanese Patent Application No. 2020-188469, filed Nov. 12, 2020, the entire content of which is incorporated herein by reference.

### BACKGROUND

### Technical Field

The present disclosure relates to a coil component and a method for manufacturing a coil component.

### Background Art

A coil component disclosed in Japanese Patent Application Laid-Open No. 2015-35473 includes a core, a plurality of metal terminals attached to the core, and a wire wound around the core. The core includes a columnar winding core and a pair of flanges provided at both ends of the winding core. When a direction orthogonal to a central axis of the winding core is defined as a first direction, each flange protrudes in the first direction from the winding core. The metal terminal is attached to the flange. An end of the wire is fixed to a distal end of the metal terminal by welding.

### SUMMARY

In the coil component disclosed in Japanese Patent Application Laid-Open No. 2015-35473, a location of the wire may be displaced with respect to the metal terminal at the time of fixing the end of the wire to the metal terminal. Depending on a degree of displacement of the location of the wire, there is a concern that welding strength between the wire and the metal terminal is insufficient or a contact failure between the wire and the metal terminal occurs.

An aspect of the present disclosure is a coil component including a core that includes a columnar winding core, and a pair of flanges provided at a first end and a second end of the winding core in a direction of a central axis and protruding outward from the winding core in a first direction orthogonal to the central axis, a wire that is wound around the winding core, and a metal terminal that is attached to each of the flange. The metal terminal includes a plate-shaped reception portion extending to a direction away from the winding core. When an extending direction of the reception portion is defined as a length direction, a direction in which a dimension of the reception portion is the smallest in directions orthogonal to the length direction is defined as a thickness direction, and a direction orthogonal to both the length direction and the thickness direction is defined as a width direction, the reception portion and the wire are connected by a melted portion that has solidified (simply referred to herein as a “melted portion”), a maximum dimension of the melted portion in the width direction is larger than a maximum dimension of the reception portion in the width direction, and the melted portion has the maximum dimension in the width direction at a portion away from the reception portion in the thickness direction.

In the above configuration, the dimension of the melted portion in the width direction is larger than the dimension of the reception portion in the width direction. The dimension of the melted portion is large as described above, and thus, although the location of the wire is slightly displaced with respect to the width direction, there is a low possibility that the end of the wire deviates from the melted portion.

The melted portion has the maximum dimension in the width direction at the portion away from the reception portion in the thickness direction. The portion where the dimension of the melted portion in the width direction is maximized is away from the reception portion in the thickness direction, and thus, although the wire is slightly displaced with respect to the thickness direction, there is a low possibility that the end of the wire deviates from the melted portion. Accordingly, the electrical connection between the wire and the metal terminal becomes more reliable.

Another aspect of the present disclosure is a method for manufacturing a coil component including a preparation step of preparing a core including a winding core and a flange, a metal terminal attachment step of attaching a metal terminal including a plate-shaped reception portion to the flange, a winding step of winding a wire around the winding core, a temporary fixing step of temporarily fixing an end of the wire to the reception portion, and a melted portion forming step of applying a laser beam to the wire and the reception portion and forming a melted portion connecting the wire and the reception portion to each other. When an end of the reception portion on a side away from the winding core is defined as a distal end and an opposite end is defined as a proximal end, in the melted portion forming step, the laser beam is applied to a location of the reception portion closer to the proximal end than a portion where the wire is temporarily fixed.

In the method for manufacturing the coil component, the laser beam is applied while avoiding a temporary fixing location, and thus, the melted portion is easily formed while maintaining a state in which the wire is temporarily fixed to the reception portion. Thus, the wire is less likely to move in the thickness direction, and the wire is less likely to deviate from the formed melted portion.

According to the aspect of the present disclosure, the connection of the wire to the metal terminal is more reliable.

### BRIEF DESCRIPTION OF THE DRAWINGS

FIG. 1 is a schematic perspective view of a coil component;

FIG. 2 is an enlarged top view of the vicinity of a reception portion of the coil component;

FIG. 3 is an enlarged side view of the vicinity of the reception portion of the coil component; and

FIG. 4 is a diagram for describing a method for manufacturing a coil component.

### DETAILED DESCRIPTION

Hereinafter, an embodiment of a coil component will be described with reference to the drawings.

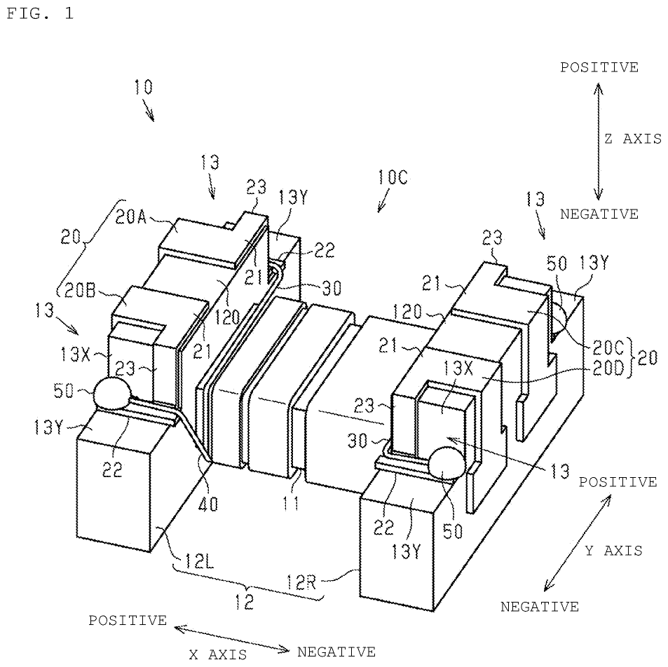

As illustrated in FIG. 1, a coil component 10 includes a core 10C, a first wire 30, a second wire 40, and four metal terminals 20.

The core 10C includes a winding core 11 and a pair of flanges 12. The winding core 11 has a square column shape. A section orthogonal to an extending direction of the winding core 11 has a rectangular shape.

Hereinafter, an axis along the extending direction of the winding core 11 is defined as an X axis. An axis orthogonal to the X axis is defined as a Y axis and an axis orthogonal to both the X axis and the Y axis is defined as a Z axis. One direction along the X axis as viewed from a specific point on the X axis is defined as a positive X direction and an opposite direction thereof is defined as a negative X direction. Similarly, one direction along the Y axis as viewed from a specific point on the Y axis is defined as a positive Y direction, an opposite direction thereof is defined as a negative Y direction, one direction along the Z axis as viewed from a specific point on the Z axis is defined as a positive Z direction, and an opposite direction thereof is defined as a negative Z direction. When the directions along the X axis, the directions along the Y axis, and the directions along the Z axis are not distinguished between the positive direction and the negative direction, these directions are simply referred to as the X direction, the Y direction, and the Z direction.

The flanges 12 are provided at ends of the winding core 11 in the positive X direction and the negative X direction, respectively. That is, the pair of flanges 12 are provided. The flange 12 protrudes outward from the winding core 11 in the Y direction and the Z direction. A dimension of the flange 12 in the X direction is smaller than a dimension of the winding core 11 in the X direction.

Among the pair of flanges 12, a first flange 12L provided at the end of the winding core 11 in the positive X direction has a shape in which two corners among four corners of a rectangular shape are recessed as viewed from the X direction. That is, the first flange 12L has a recessed portion 13 at a corner in the positive Z direction and the positive Y direction. The first flange 12L has a recessed portion 13 at a corner in the positive Z direction and the negative Y direction. The recessed portion 13 has a square shape as viewed from the X direction. Thus, the recessed portion 13 has a first surface 13X orthogonal to the Y axis and a second surface 13Y orthogonal to the Z axis. The recessed portions 13 are located in the positive Z direction, that is, outside the winding core 11.

A surface of the first flange 12L located closest to the positive Z direction except for the second surface 13Y of the recessed portion 13 is a mounting surface 120. The mounting surface 120 is a surface facing a mounting substrate at the time of mounting the coil component 10.

A second flange 12R provided at the end of the winding core 11 in the negative X direction has a symmetrical shape with the first flange 12L provided at the end of the winding core 11 in the positive X direction. In the following description, when it is not necessary to distinguish between the first flange 12L and the second flange 12R, these flanges may be collectively referred to as the flange 12.

A material of the core 10C including the winding core 11 and the pair of flanges 12 is a non-conductive material. Specifically, the material of the core 10C can be, for example, alumina, Ni-Zn-based ferrite, resin, or a mixture thereof. The pair of flanges 12 are connected to each other by a plate material made of the same material as the material of the core 10C, and may be a core of a closed magnetic circuit.

A first metal terminal 20A, which is one of the four metal terminals 20, is attached to a portion of the first flange 12L on the positive Y direction side with respect to a center of the winding core 11 in the Y direction. The first metal terminal 20A includes an attachment portion 21 to be attached to the first flange 12L, a reception portion 22 to which the first wire 30 is connected, and a coupling portion 23 connecting the attachment portion 21 and the reception portion 22.

The attachment portion 21 extends across an outer surface of the first flange 12L in the X direction and the mounting surface 120. Thus, the attachment portion 21 has an L shape when viewed from the Y direction.

The coupling portion 23 is connected to the attachment portion 21. The coupling portion 23 extends from an outer end of the attachment portion 21 in the Y direction. The coupling portion 23 extends across the mounting surface 120 and the first surface 13X of the recessed portion 13. Thus, the coupling portion 23 has an L shape when viewed from the X direction.

The reception portion 22 is connected to the coupling portion 23. The reception portion 22 extends from an end of the coupling portion 23 opposite to the attachment portion 21. The reception portion 22 extends in the X direction along the second surface 13Y of the recessed portion 13. Specifically, the reception portion 22 extends in a direction away from the winding core 11 in the X direction from the coupling portion 23.

Hereinafter, a direction in which the reception portion 22 extends, that is, the X direction is defined as a length direction of the reception portion 22. Of directions orthogonal to the length direction, a direction in which a dimension of the reception portion 22 is the smallest is defined as a thickness direction of the reception portion 22, and a direction orthogonal to both the length direction and the thickness direction is defined as a width direction of the reception portion 22. In this embodiment, the thickness direction of the reception portion 22 coincides with the Z direction, and the width direction of the reception portion 22 coincides with the Y direction. The reception portion 22 has a substantially rectangular shape in which a dimension in the length direction is longer than a dimension in the width direction. The reception portion 22 has a substantially constant dimension in the thickness direction over the entire reception portion.

The coil component 10 includes a second metal terminal 20B disposed at a portion of the first flange 12L on the negative Y direction side with respect to the center of the winding core 11 in the Y direction in addition to the first metal terminal 20A described above. The coil component 10 includes a third metal terminal 20C disposed at a portion of the second flange 12R on the positive Y direction side with respect to the center of the winding core 11 in the Y direction, and a fourth metal terminal 20D disposed at a portion of the second flange 12R on the negative Y direction side with respect to the center of the winding core 11 in the Y direction. When it is not necessary to distinguish between the first metal terminal 20A to the fourth metal terminal 20D, these metal terminals may be collectively referred to as metal terminals 20.

The second metal terminal 20B has a shape substantially symmetrical with respect to the first metal terminal 20A with a central axis passing through the center of the winding core 11 in the Y direction and extending in the X direction. The third metal terminal 20C has a shape substantially symmetrical with respect to the first metal terminal 20A in the X direction. The fourth metal terminal 20D has a shape substantially symmetrical with respect to the second metal terminal 20B in the X direction. Each of the second metal terminal 20B to the fourth metal terminal 20D also includes the attachment portion 21, the reception portion 22, and the coupling portion 23. Since the shapes of the attachment portion 21, the reception portion 22, and the coupling portion 23 are the same as the shape of the first metal terminal 20A, the same reference signs are given and the description thereof is omitted.

As illustrated in FIG. 1, the coil component 10 includes the first wire 30. A section orthogonal to an extending direction of the first wire 30 has a circular shape. One end of the first wire 30 is connected to the reception portion 22 of the first metal terminal 20A. Specifically, one end of the first wire 30 is connected to the reception portion 22 with a melted portion 50 interposed therebetween. The melted portion 50 is formed by heating and melting a part of the first wire 30 and a part of the reception portion 22 of the first metal terminal 20A and then curing these parts.

The first wire 30 extends from the first metal terminal 20A toward the corner closest to the second metal terminal 20B among the four corners of the winding core 11, and is wound around the winding core 11. That is, when the winding core 11 is viewed from the positive X direction, the first wire 30 is wound around the winding core 11 in a clockwise direction.

A portion in the vicinity of the other end of the first wire 30 extends toward the third metal terminal 20C from a corner farthest from the fourth metal terminal 20D among the four corners of the winding core 11 in the vicinity of the second flange 12R of the winding core 11. The other end of the first wire 30 is connected to the reception portion 22 of the third metal terminal 20C. Specifically, the other end of the first wire 30 is connected to the reception portion 22 with the melted portion 50 interposed therebetween.

The coil component 10 includes the second wire 40. A section orthogonal to an extending direction of the second wire 40 has the same circular shape as the first wire 30. One end of the second wire 40 is connected to the reception portion 22 of the second metal terminal 20B. Specifically, one end of the second wire 40 is connected to the reception portion 22 with the melted portion 50 interposed therebetween.

The second wire 40 extends from the second metal terminal 20B toward the corner on a side farthest from the first metal terminal 20A among the four corners of the winding core 11, and is wound around the winding core 11. That is, when the winding core 11 is viewed from the positive X direction, the second wire 40 is wound around the winding core 11 in the same clockwise direction as the first wire 30.

A portion in the vicinity of the other end of the second wire 40 extends from a corner closest to the third metal terminal 20C among the four corners of the winding core 11 toward the fourth metal terminal 20D in the vicinity of the second flange 12R of the winding core 11. The other end of the second wire 40 is fixed to the reception portion 22 of the fourth metal terminal 20D. Specifically, the other end of the second wire 40 is fixed to the reception portion 22 with the melted portion 50 interposed therebetween.

Next, the configuration of the reception portion 22 and the vicinity thereof will be described in detail. In the following description, although the first metal terminal 20A and the first wire 30 will be described as an example, the same applies to the second metal terminal 20B to the fourth metal terminal 20D and the second wire 40. An end of the reception portion 22 on a side away from the winding core 11 is described as a distal end, and an opposite end thereof is described as a proximal end.

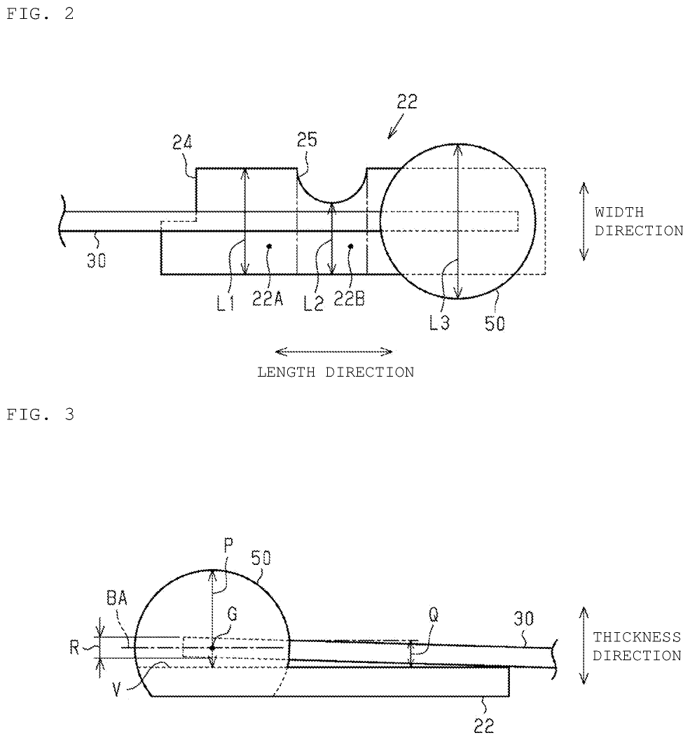

As illustrated in FIG. 2, the reception portion 22 includes a base portion 22A and a narrowed portion 22B in order from a portion on a side closer to the proximal end in the length direction. Specifically, the reception portion 22 has a first cutout portion 24 recessed from one edge in the width direction to the other edge in the width direction. The first cutout portion 24 is located at the proximal end in the length direction. Thus, the first cutout portion 24 is also opened to the proximal end side. The first cutout portion 24 has a rectangular shape as viewed from the thickness direction.

The reception portion 22 has a second cutout portion 25 recessed from one edge in the width direction to the other edge in the width direction. The second cutout portion 25 is located on a side closer to the distal end than the first cutout portion 24 in the length direction of the reception portion 22. That is, the second cutout portion 25 is disposed away from the first cutout portion 24. The second cutout portion 25 has a semicircular shape as viewed from the thickness direction.

The reception portion 22 has a constant dimension in the width direction except for a portion where the first cutout portion 24 and the second cutout portion 25 are provided in the length direction. Thus, a region of the reception portion 22 where the second cutout portion 25 is provided in the length direction is the narrowed portion 22B of which a dimension in the width direction is reduced. The entire region of the reception portion 22 on the side closer to the proximal end than the second cutout portion 25 in the length direction is the base portion 22A. In FIG. 2, the narrowed portion 22B is virtually surrounded by a dashed dotted line.

A dimension of the narrowed portion 22B in the width direction is smaller than a maximum dimension L1 of the base portion 22A in the width direction, that is, a dimension of the portion where the first cutout portion 24 is not provided in the width direction in the entire region. A radius of the second cutout portion 25 described above is about ⅓ of the maximum dimension L1 of the base portion 22A in the width direction. As a result, a minimum dimension L2 of the narrowed portion 22B in the width direction is about ⅔ of the maximum dimension L1 of the base portion 22A in the width direction.

As described above, the reception portion 22 has substantially the same dimension in the thickness direction as a whole. Thus, a difference in dimension in the width direction is reflected, a sectional area of the narrowed portion 22B orthogonal to the length direction is smaller than a maximum sectional area of the base portion 22A orthogonal to the length direction. Specifically, a minimum sectional area of the narrowed portion 22B orthogonal to the length direction is about ⅔ of the maximum sectional area of the base portion 22A orthogonal to the length direction.

As illustrated in FIG. 2, the reception portion 22 is connected to the first wire 30 at the melted portion 50 on a side closer to the distal end than the second cutout portion 25. As described above, although the melted portion 50 is formed by melting and then curing the part of the reception portion 22 and the part of the first wire 30, the reception portion 22 and the first wire 30 before being melted are virtually illustrated by broken lines in FIG. 2.

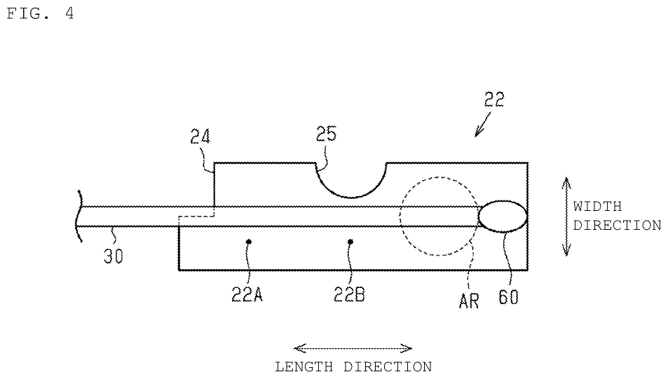

As illustrated in FIG. 3, the melted portion 50 has a shape in which a part of a spherical shape is cut out by a plane orthogonal to the thickness direction of the reception portion 22. Thus, as illustrated in FIG. 2, although the melted portion 50 clearly illustrates a boundary between the reception portion 22 and the first wire 30, these portions may be integrated and the boundary may not be clear.

As illustrated in FIG. 2, a maximum dimension L3 of the melted portion 50 in the width direction is larger than a maximum dimension of the reception portion 22 in the width direction. That is, a diameter of the melted portion 50 is larger than the maximum dimension L1 of the base portion 22A. A center of the melted portion 50 in the width direction coincides with a center of the reception portion 22 in the width direction. Thus, as viewed from the thickness direction, a part of the melted portion 50 protrudes outward from both edges of the reception portion 22 in the width direction.

As illustrated in FIG. 3, the melted portion 50 has the maximum dimension in the width direction at a portion G away from the reception portion 22 in the thickness direction of the reception portion 22. For example, in FIG. 3, the melted portion 50 has the maximum dimension in the width direction above an upper surface of the reception portion 22. Here, in the melted portion 50, a shortest distance from a portion of the melted portion 50 farthest from the reception portion 22 in the thickness direction to the reception portion 22 is defined as a first distance P. A shortest distance from a portion of the first wire 30 farthest from the reception portion 22 in the thickness direction to the reception portion 22 at a connection portion between the melted portion 50 and the first wire 30 is defined as a second distance Q. In the present embodiment, the second distance Q is 0.3 times the first distance P. In order to prevent the first wire 30 from deviating from the melted portion 50, the second distance Q is preferably 0.9 times or less the first distance P.

In the present embodiment, a boundary between the melted portion 50 and the reception portion 22 may not be discriminated inside the melted portion 50. In this case, the first distance P is set to a shortest distance from the portion of the melted portion 50 farthest from the reception portion 22 to a virtual plane V obtained by extending a surface of the reception portion 22 exposed from the melted portion 50 in the length direction. When the boundary between the melted portion 50 and the reception portion 22 cannot be discriminated, the second distance Q is similarly set to a shortest distance from the portion of the first wire 30 farthest from the reception portion 22 in the thickness direction to the virtual plane V obtained by extending the surface of the reception portion 22 exposed from the melted portion 50 in the length direction.

When a location where a dimension of the melted portion 50 in the width direction is maximized in the thickness direction of the reception portion 22 is defined as a reference location BA, the first wire 30 is more preferably connected to the melted portion 50 within a range R of ±10% of the first distance P in the thickness direction from the reference location BA.

Next, a manufacturing method of the present embodiment will be described.

First, a preparation step in the method for manufacturing the coil component 10 will be described. Initially, in the preparation step, the core 10C formed as follows is prepared. The core 10C is formed by mixing a Ni-Zn-based ferrite powder with a synthetic resin binder and firing a molded body formed by press molding. Accordingly, the columnar winding core 11 and the core 10C having the flanges 12 at the end in the positive direction and the end in the negative direction in the X direction of the winding core 11 are formed.

Subsequently, in a metal terminal attachment step, the metal terminals 20 manufactured as follows are attached to the core 10C. The metal terminals 20 are formed by performing sheet metal working on one metal plate made of a copper-based alloy such as phosphor bronze. Accordingly, the attachment portion 21, the reception portion 22, and the coupling portion 23 described above are formed on the metal terminal 20.

Here, in the sheet metal working described above, the first cutout portion 24 and the second cutout portion 25 are formed in the reception portion 22. The first cutout portion 24 is formed on the side closer to the proximal end than the connection portion between the reception portion 22 and the coupling portion 23 in the length direction of the reception portion 22.

The second cutout portion 25 is formed on the side closer to the distal end than the above-described connection portion. As a result, the base portion 22A and the narrowed portion 22B are formed in the reception portion 22. The base portion 22A and the narrowed portion 22B are formed in order from the portion close to a proximal end of the winding core 11 such that the minimum sectional area of the narrowed portion 22B orthogonal to the length direction is smaller than the maximum sectional area of the base portion 22A orthogonal to the length direction. In the present embodiment, the minimum sectional area of the narrowed portion 22B is ¾ or less of the maximum sectional area of the base portion 22A.

In the metal terminal attachment step, the attachment portion 21 of the metal terminal 20 formed as described above is disposed so as to be in contact with the mounting surface 120 which is a surface of an end of the flange 12 in the positive Z direction and an outer end surface of the flange 12 in the X direction. As a result, the metal terminal 20 is attached to the flange 12, and the reception portion 22 extends in the direction away from the winding core 11.

Next, a winding step will be described.

The first wire 30 and the second wire 40 are wound around the core 10C. One end of the first wire 30 is disposed so as to be in the vicinity of the reception portion 22 of the first metal terminal 20A, and the first wire 30 is wound around the winding core 11 as described above. The other end of the first wire 30 is disposed so as to be in the vicinity of the reception portion 22 of the third metal terminal 20C. One end of the second wire 40 is disposed so as to be in the vicinity of the reception portion 22 of the second metal terminal 20B, and the second wire 40 is wound around the winding core 11 as described above. The other end of the second wire 40 is disposed so as to be in the vicinity of the reception portion 22 of the fourth metal terminal 20D.

Next, a temporary fixing step will be described.

Hereinafter, although a method for forming the melted portion 50 in the reception portion 22 of the first metal terminal 20A and connecting the first wire 30 to the reception portion will be described, the same applies to connection between the second metal terminal 20B to the fourth metal terminal 20D and the first wire 30 or the second wire 40.

One end of the first wire 30 is temporarily fixed at a location of the reception portion 22 closer to the distal end than the narrowed portion 22B. For example, as illustrated in FIG. 4, the first wire 30 is temporarily fixed by thermal pressure bonding at a temporary fixing location 60 at the distal end of the reception portion 22. At the time of temporary fixing, a contact portion between the reception portion 22 and the first wire 30 is mainly melted and cured, but the melted portion 50 is not formed yet. A distal end of the first wire 30 is temporarily fixed to the reception portion 22, and thus, the first wire 30 is disposed along one surface of the reception portion 22 in the thickness direction. The temporary fixing location 60 in the reception portion 22 is desirably plated with tin. Plating is performed with tin having a low melting point, and thus, the first wire 30 can be temporarily fixed easily.

Next, a melted portion forming step will be described.

Of one surface of the reception portion 22 in the thickness direction, a laser beam is applied to a portion closer to a proximal end of the first wire 30 than the temporary fixing location 60 and a region AR closer to the distal end than the narrowed portion 22B. Thus, the region AR of the reception portion 22 and the reception portion 22 on the side closer to the distal end than the region AR are melted. The part of the melted reception portion 22 and the part of the first wire 30 become substantially spherical due to surface tension, and then are cured to become the melted portion 50. However, the other side of the melted portion 50 in the thickness direction has a planar shape by reflecting that the reception portion 22 has a plate shape. When the part of the reception portion 22 and the part of the first wire 30 are melted, the temporary fixing of the first wire 30 to the reception portion 22 is released, and thus, the constraint of the first wire 30 may be temporarily released. However, the reception portion 22 and the first wire 30 are finally connected by the melted portion 50. When the laser beam is applied from the other surface of the reception portion 22 in the thickness direction, that is, a surface side not adjacent to the first wire 30, the melted portion 50 may be formed on the other surface of the reception portion 22. When the melted portion 50 is formed on the other surface of the reception portion 22, the reception portion 22 and the first wire 30 are hardly connected by the melted portion 50. Thus, in the present embodiment, the laser beam is applied from one surface side of the reception portion 22 in the thickness direction.

Next, effects of the present embodiment will be described. Hereinafter, although the reception portion 22 of the first metal terminal 20A and the melted portion 50 of the first wire 30 will be described, the same applies to the connection between the second metal terminal 20B to the fourth metal terminal 20D and the first wire 30 or the second wire 40.

(1) In the above embodiment, the maximum dimension L3 of the melted portion 50 in the width direction is larger than the maximum dimension L1 of the reception portion 22 in the width direction. Thus, for example, although the location of the first wire 30 is slightly displaced with respect to the width direction, there is a low possibility that the end of the first wire 30 deviates from the melted portion 50. Specifically, When the deviation of the first wire 30 in the width direction is within a dimensional range of the reception portion 22 in the width direction, it is unlikely that the first wire 30 deviates from the melted portion 50. Thus, the electrical connection between the first wire 30 and the first metal terminal 20A becomes more reliable. In the above embodiment, the melted portion 50 has the maximum dimension in the width direction at the portion G away from the reception portion 22 in the thickness direction. Since the melted portion 50 has the substantially spherical shape, it is easy to set the first distance P to be large by reflecting the size of the dimension in the width direction. Accordingly, for example, although the location of the first wire 30 is slightly displaced with respect to the thickness direction, there is a low possibility that the end of the first wire 30 deviates from the melted portion 50.

(2) In the above embodiment, in the reception portion 22, there is the narrowed portion 22B having the sectional area smaller than the maximum sectional area of the base portion 22A. Specifically, the minimum sectional area of the narrowed portion 22B is about ⅔ of the maximum sectional area of the base portion 22A. Thus, heat applied to the reception portion 22 is less likely to be transferred with the portion of the narrowed portion 22B having the smallest sectional area as the boundary. Accordingly, the laser beam is applied to the side closer to the distal end in the length direction than the narrowed portion 22B, and thus, heat associated with the laser beam application is less likely to escape to the side closer to the proximal end in the length direction than the narrowed portion 22B. It is easy to form the large melted portion 50 without increasing an output of the laser beam. The laser beam is applied while avoiding the temporary fixing location 60, and thus, it is easy to form the melted portion 50 while maintaining a state in which the first wire 30 is temporarily fixed to the reception portion 22. Thus, the first wire 30 is less likely to move in the thickness direction, and is less likely to deviate from the melted portion 50.

(3) In the above embodiment, the second distance Q between the first wire 30 and the reception portion 22 is about 0.3 times the first distance P. As described above, when the second distance Q is smaller than the first distance P, the first wire 30 is connected to the melted portion 50 at the portion close to the reception portion 22. Thus, the deviation of the first wire 30 from the melted portion 50 can be suppressed. As described above, the second distance Q is preferably 0.9 times or less the first distance P from the above viewpoint. The first wire 30 is more preferably connected to the melted portion 50 within the range of ±10% of the first distance P in the thickness direction from the reference location BA. That is, the first wire 30 may be connected to the melted portion 50 in the vicinity of the location where the width direction is the largest in the melted portion 50.

(4) For example, it is assumed that the dimension of the narrowed portion 22B in the thickness direction is set to be smaller than the dimension of the base portion 22A in the thickness direction without changing the dimensions of the narrowed portion 22B and the base portion 22A in the width direction. In this configuration, the sectional area of the narrowed portion 22B is also smaller than the sectional area of the base portion 22A. However, since the melted portion 50 is formed on the main surface of the reception portion 22, it is easy to apply a load in the thickness direction to the narrowed portion 22B due to a weight of the melted portion 50 or the like. In this regard, in the above embodiment, the reception portion 22 has the substantially constant thickness over the entire reception portion, and there is no portion locally weak against the force in the thickness direction. Accordingly, it is possible to prevent the reception portion 22 from being deformed when the melted portion 50 is formed.

(5) When the dimension of the narrowed portion 22B in the width direction is too small, strength decreases, and the narrowed portion becomes weak against impact. However, when there is almost no difference between the dimension of the narrowed portion 22B in the width direction and the dimension of the base portion 22A in the width direction, it is less likely to obtain the effect of the narrowed portion 22B that suppresses the heat of the laser beam from being transferred to the side close to the proximal end of the base portion 22A as described above. Thus, the dimension of the narrowed portion 22B in the width direction is preferably ⅓ or more and ¾ or less (i.e., from ⅓ to ¾) of the dimension of the base portion 22A in the width direction. In the above embodiment, since the dimension of the narrowed portion 22B in the width direction is about ⅔ of the dimension of the base portion 22A in the width direction, the effect of the narrowed portion 22B described above can be easily obtained.

The present embodiment can be modified as follows. The present embodiment and the following modification examples can be implemented in combination with each other within a range not technically contradictory.

In the above embodiment, the winding core 11 may not have a rectangular columnar shape. For example, the winding core may have a cylindrical shape.

In the above embodiment, the number of wires may be one. In the case of one wire, at least one metal terminal 20 may be provided for one flange 12. In this case, the reception portion 22 of the metal terminal 20 may also extend in the direction away from the winding core 11.

In the above embodiment, the shape of the metal terminal 20 is not limited to the example of the above embodiment. For example, the first cutout portion 24 may not be provided.

In the above embodiment, the shapes of the first cutout portion 24 and the second cutout portion 25 are not limited to the examples of the above embodiment. For example, the shape of the second cutout portion 25 may be a square as viewed from the thickness direction. The minimum dimension of the narrowed portion 22B in the width direction may be smaller than ⅓ of the maximum dimension of the base portion 22A in the width direction according to the change of the shape of the cutout portion. In the above embodiment, the minimum sectional area of the narrowed portion 22B orthogonal to the length direction may be larger than ¾ of the maximum sectional area of the base portion 22A orthogonal to the length direction.

In the above embodiment, the second cutout portion 25 may be cut out from both sides of one end and the other end of the reception portion 22 in the width direction. When there are two second cutout portions 25 as described above, the locations of the cutout portions 25 may not be the same location in the length direction of reception portion 22. The shapes of the cutout portions 24 and 25 may not be the same.

In the above embodiment, the length direction may not coincide with the X direction. That is, the reception portion 22 may extend at an angle with respect to the X direction.

In the reception portion 22 of the above embodiment, the second cutout portion 25 is not necessarily required. For example, when the dimension of the narrowed portion 22B in the thickness direction is smaller than the dimension of the base portion 22A in the thickness direction, the sectional area of the narrowed portion 22B is smaller than the sectional area of the base portion 22A although the minimum dimension L2 of the narrowed portion 22B in the width direction is the same as the maximum dimension L1 of the base portion 22A in the width direction.

In the above embodiment, the melted portion 50 may protrude from the reception portion 22 in the width direction on one side of the reception portion 22. For example, at the time of forming the melted portion 50, when the laser beam is applied to be closer to any one side than the center of the reception portion 22 in the width direction, the melted portion 50 may be formed depending on the application location side. A part of the melted portion 50 may protrude to the second cutout portion 25.

In the above embodiment, the shape of the melted portion 50 is not limited to the example of the above embodiment. In the above embodiment, although the melted portion 50 is illustrated as having a substantially hemispherical shape, the melted reception portion 22 may wrap around to a lower side of the reception portion 22 in the thickness direction, and the melted portion may be substantially spherical. The melted portion 50 may have any shape.

In the above embodiment, the location where the wire is connected to the melted portion 50 may be out of the above-described range R. For example, since the wire extends along the surface of the reception portion 22, the location of the wire is hardly displaced toward the reception portion 22. Accordingly, when the wire is connected closer to the reception portion 22 than the range R in the thickness direction, there is a low possibility that the wire deviates from the melted portion 50.

In the above embodiment, the second distance Q between the first wire 30 and the reception portion 22 may be larger than 0.9 times the first distance P.

In the above embodiment, there may be a portion where the dimension in the width direction is enlarged in part in the reception portion 22 before the laser beam is applied. For example, in the length direction of the reception portion 22, the dimension of the reception portion 22 in the width direction may be larger on the side closer to the distal end than the region AR to which the laser beam is applied. In such a case, since a volume of the reception portion 22 to be melted increases, a larger melted portion 50 is likely to be formed.

In the above embodiment, the method for manufacturing the core 10C prepared in the preparation step is not limited to the example of the above embodiment, and for example, the core 10C may be formed by grinding a rectangular parallelepiped ferrite core.

In the above embodiment, the method for manufacturing the metal terminal 20 attached to the core 10C in the metal terminal attachment step is not limited to the example of the above embodiment. For example, the metal terminal 20 may be formed by casting or the like.

In the above embodiment, the method for forming the melted portion 50 may not be the laser beam application. For example, the melted portion 50 may be formed by solder or the like instead of forming the reception portion 22 by melting.

In the above embodiment, the temporary fixing of the first wire 30 and the second wire 40 may not be thermal pressure bonding. For example, the reception portion 22 and the wires 30 and 40 may be temporarily fixed with an adhesive.

In the above embodiment, the laser beam application location at the time of forming the melted portion 50 may not be the region AR. For example, the laser application location may overlap the temporary fixing location 60.

What is claimed is:

1. A coil component, comprising:
a core that includes a columnar winding core, and a pair of flanges respectively at a first end and a second end of the winding core in a direction of a central axis and protruding outward from the winding core in a first direction orthogonal to the central axis;
a wire that is wound around the winding core; and
a respective metal terminal that is attached to each of the flanges,
the metal terminal including a plate-shaped reception portion extending to a direction away from the winding core, and
when an extending direction of the reception portion is defined as a length direction, a direction in which a dimension of the reception portion is the smallest of directions orthogonal to the length direction is defined as a thickness direction, and a direction orthogonal to both the length direction and the thickness direction is defined as a width direction,
the reception portion and the wire being connected by a melted portion that has solidified,
a maximum dimension of the melted portion in the width direction being larger than a maximum dimension of the reception portion in the width direction, and
the melted portion having the maximum dimension in the width direction at a portion away from the reception portion in the thickness direction.

2. The coil component according to claim 1, wherein
when an end of the reception portion on a side away from the winding core is defined as a distal end and an opposite end is defined as a proximal end,
the reception portion includes a base portion and a narrowed portion in order from a side close to the proximal end in the length direction, and
a minimum cross sectional area of the narrowed portion orthogonal to the length direction is ¾ or less of a maximum cross sectional area of the base portion orthogonal to the length direction.

3. The coil component according to claim 1, wherein
when
a shortest distance from a portion of the melted portion farthest from the reception portion to the reception portion in the thickness direction of the melted portion is defined as a first distance, and
a shortest distance from a portion of the wire farthest from the reception portion in the thickness direction to the reception portion at a connection portion between the melted portion and the wire is defined as a second distance,
the second distance is 0.9 times or less the first distance.

4. The coil component according to claim 1, wherein
the reception portion includes a base portion and a narrowed portion in order from a side close to the winding core in the length direction, and
a minimum dimension of the narrowed portion in the width direction is smaller than a maximum dimension of the base portion in the width direction.

5. The coil component according to claim 4, wherein
the minimum dimension of the narrowed portion in the width direction is ⅓ or more than the maximum dimension of the base portion in the width direction.

6. The coil component according to claim 1, wherein
when
a shortest distance from a portion of the melted portion farthest from the reception portion to the reception portion in the thickness direction of the melted portion is defined as a first distance, and
a shortest distance from a portion of the wire farthest from the reception portion in the thickness direction to the reception portion at a connection portion between the melted portion and the wire is defined as a second distance,
the second distance is 0.9 times or less the first distance.

7. The coil component according to claim 2, wherein
the reception portion includes a base portion and a narrowed portion in order from a side close to the winding core in the length direction, and
a minimum dimension of the narrowed portion in the width direction is smaller than a maximum dimension of the base portion in the width direction.

8. The coil component according to claim 3, wherein
the reception portion includes a base portion and a narrowed portion in order from a side close to the winding core in the length direction, and
a minimum dimension of the narrowed portion in the width direction is smaller than a maximum dimension of the base portion in the width direction.

9. The coil component according to claim 7, wherein
the reception portion includes a base portion and a narrowed portion in order from a side close to the winding core in the length direction, and
a minimum dimension of the narrowed portion in the width direction is smaller than a maximum dimension of the base portion in the width direction.

10. The coil component according to claim 7, wherein
the minimum dimension of the narrowed portion in the width direction is ⅓ or more than the maximum dimension of the base portion in the width direction.

11. The coil component according to claim 8, wherein
the minimum dimension of the narrowed portion in the width direction is ⅓ or more than the maximum dimension of the base portion in the width direction.

12. The coil component according to claim 9, wherein the minimum dimension of the narrowed portion in the width direction is ⅓ or more than the maximum dimension of the base portion in the width direction.

13. A method for manufacturing a coil component, comprising:
preparing a core including a winding core and a flange;
attaching a metal terminal including a plate-shaped reception portion to the flange;
winding a wire around the winding core;
temporarily fixing an end of the wire to the reception portion; and
applying a laser beam to the wire and the reception portion to form a melted portion connecting the wire and the reception portion to each other,
when an end of the reception portion on a side away from the winding core is defined as a distal end and an opposite end is defined as a proximal end, in the applying of the laser beam, the laser beam is applied to a location of the reception portion closer to the proximal end than a portion where the wire is temporarily fixed.

14. The method for manufacturing a coil component according to claim 13, wherein
when an extending direction of the reception portion is defined as a length direction,
the reception portion includes a base portion and a narrowed portion in order from a side close to the proximal end in the length direction,
a minimum cross sectional area of the narrowed portion orthogonal to the length direction is smaller than a maximum cross sectional area of the base portion orthogonal to the length direction,
in the temporary fixing, the wire is temporarily fixed to a location closer to the distal end of the reception portion than the narrowed portion of the reception portion, and
in the applying of the laser beam, the laser beam is applied between a location of the reception portion to which the wire is temporarily fixed and the narrowed portion.
